(19) United States
(12) Patent Application Publication
(10) Pub. No.: US 2006/0125618 A1
(43) Pub. Date: Jun. 15, 2006

(54) Automobile warning device

(76) Inventor: Richard Hsu, Kaohsiung (TW)

Correspondence Address: LEONG C LEI, PMB # 1008, 1867 YGNACIO VALLEY ROAD, WALNUT CREEK, CA, 94598, US

(21) Appl. No.: 11/002,419

(22) Filed: Dec. 3, 2004

(51) Int. Cl. B60Q 1/26

(52) U.S. Cl. 340/468

(57) ABSTRACT

An automobile warning device is comprised of a warning lamp adapted with a radio receiver being mounted to the body at where can be easily seen and a radio transmitter being coupled to an actuation system of any indicator in the automobile; the warning lamp being synchronously illuminated upon receiving the signal of activating the indicator adapted with the transmitter to improve indication and warning effects, thus to upgrade drive safety.

### BACKGROUND OF THE INVENTION

(a) Technical Field of the Invention

The present invention is related to an automobile warning device, and more particularly, to a warning lamp adapted with a radio receiver to improve warning effects, and thus the drive safety.

(b) Description of the Prior Art

Whereas headlamps are mounted to any automobile, many indicators including the direction indicator control lamps, the brake lamp, and the back lamp are provided to indicate its corresponding movement of the automobile.

As illustrated in FIG. 1 of the accompanying drawings, the quality of the performance of a headlamp 1 of an automobile is determined by its luminance. Additional to luminance, the angle of installation that provides good visual contact is also demanded on a direction indicator control lamp 21 of the indication lamp 2. The importance of whether the optimal location on the body for the installation of the direction indicator control lamp 21 is particularly addressed on considering that the visual contact of the direction indicator control lamp 21 by other drivers always changes. Furthermore, a brake lamp 22 is turned on when the vehicle is deceleration or having a sudden brake so to warn the other drivers of the braking to avoid collision. Similar to the direction indicator control lamp 21, other than the luminance, the location for the installation of the back lamp 22 is also highly demanded.

However, not all the indicators 2 are mounted to the optimal locations on the body of the automobile where can be always easily seen, particularly true to a larger car as illustrated in FIG. 2. The huge body of the larger automobiles is vulnerable to create dead angle for the visual contact, thus to compromise the purpose of indication and/or warning effects.

Though the automobile, the larger one or the smaller one, has mounted on its body multiple indicators 2 for warning purpose, the dead angle of visual contact is frequently created since the location of the automobile is always changing its direction by taking a turn or driving straight ahead. As a result, the ignorance of the warning lamp contributes to most of the traffic accidents.

### SUMMARY OF THE INVENTION

The primary purpose of the present invention is to provide an additional automobile warning device to improve the warning effects of a driving automobile. To achieve the purpose, the warning device includes a warning lamp adapted with a radio receiver, and a radio transmitter. The warning lamp is mounted on the body of the automobile at where can be easily seen by other drivers on the road, and is turned on upon receiving signal sent from the transmitter.

Another purpose of the present invention is to provide an additional automobile warning device to improve the warning effects of a driving automobile and to upgrade drive safety. To achieve the purpose, the warning device includes a warning lamp adapted with a radio receiver, and a radio transmitter. The warning lamp is mounted on the body of the automobile at where can be easily seen by other drivers on the road. The radio transmitter is coupled to an actuation system of any existing indicator in the automobile. Accordingly, when the actuation system of that indicator is started, the signal is sent by the ratio transmitter to the radio receiver of the warning lamp, and the warning lamp is turned on synchronously with that indicator upon the radio receiver in the warning lamp picks up the signal.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing multiple lamps of the prior art mounted to the body of an automobile.

FIG. 2 is a schematic view showing multiple lamps of the prior art mounted to the body of a larger vehicle.

FIG. 3 is a block diagram showing the application of the present invention.

FIG. 4 is a schematic view showing the assembly of a modulus of the present invention.

FIG. 5 is a schematic view showing an application of the present invention.

FIG. 6 is a schematic view showing another application of the present invention.

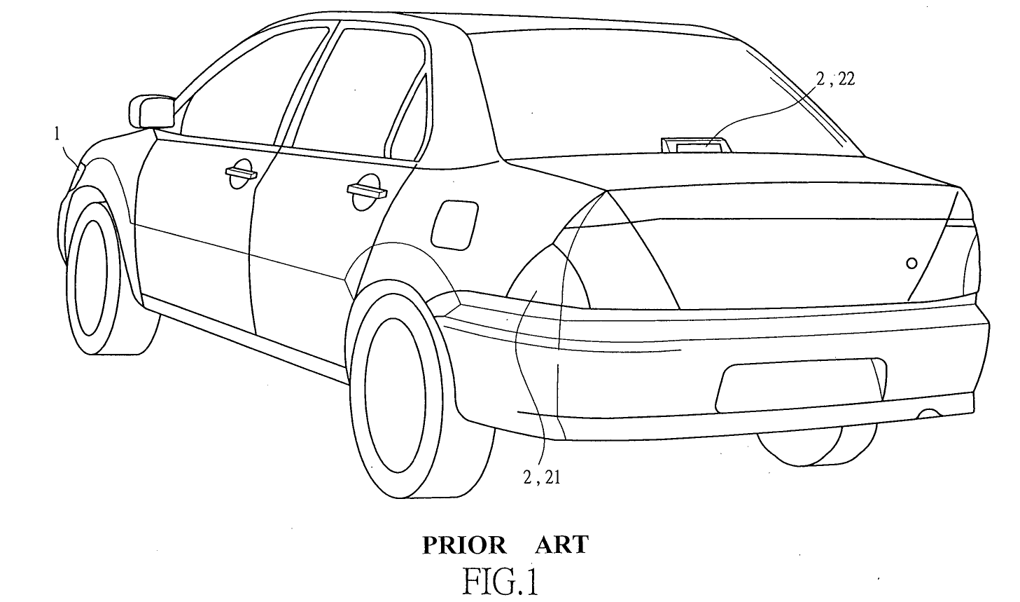

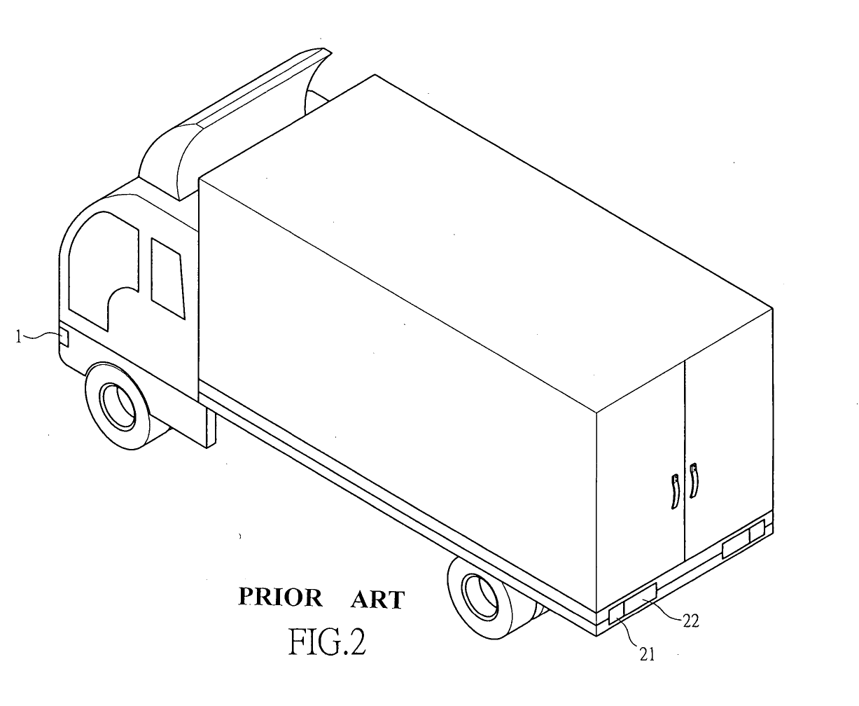

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

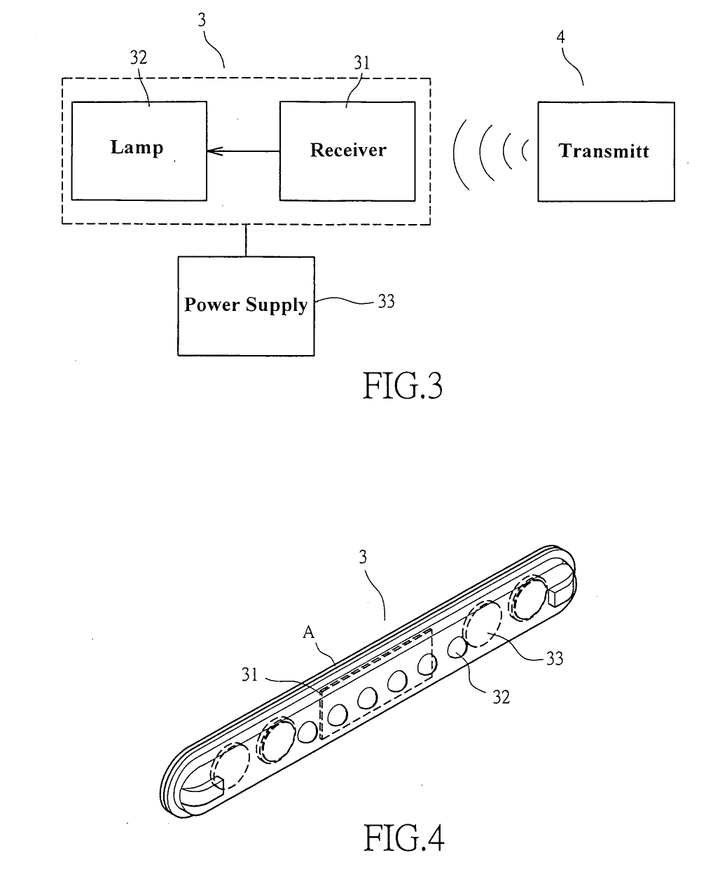

Referring to FIG. 3, the present invention is essentially comprised of a warning lamp 3 adapted with a radio receiver, and a radio transmitter 4. The warning lamp 3 contains a radio receiver 31 to pick up signals of encrypted code and frequency, and is connected to a set of bulb 32. The operation of the set of bulb 32 is under the control by the radio receiver 31. The set of bulb 32 may be related to a single bulb or multiple bulbs in the form of a tungsten lamp or an LED bulb in color of red, yellow, or any other color as applicable. The bulb may be designed for constant or intermittent light emission. Furthermore, a power supply 33 is provided exclusively for the warning lamp 3.

The radio transmitter 4 sends signals of encrypted code and frequency. Of course the encrypted code and frequency to be sent by the transmitter 4 may be preset for the matching radio receiver 31 to pick up. The transmitter 4 provides sufficient transmission power strength to ensure good reception by the radio sign receiver 31.

As illustrated in FIG. 4, the warning lamp 3 is designed in a modulus part and a base A is provided to accommodate the radio receiver 31, the bulb 32, and the power supply 33. The base A may be fixed with double-sided adhesive tape, magnet, or screw to any location on the body of the automobile at where can be easily seen to reinforce the warning effects where the existing indicators including the direction indicator control lamps, and the brake lamp are found insufficient.

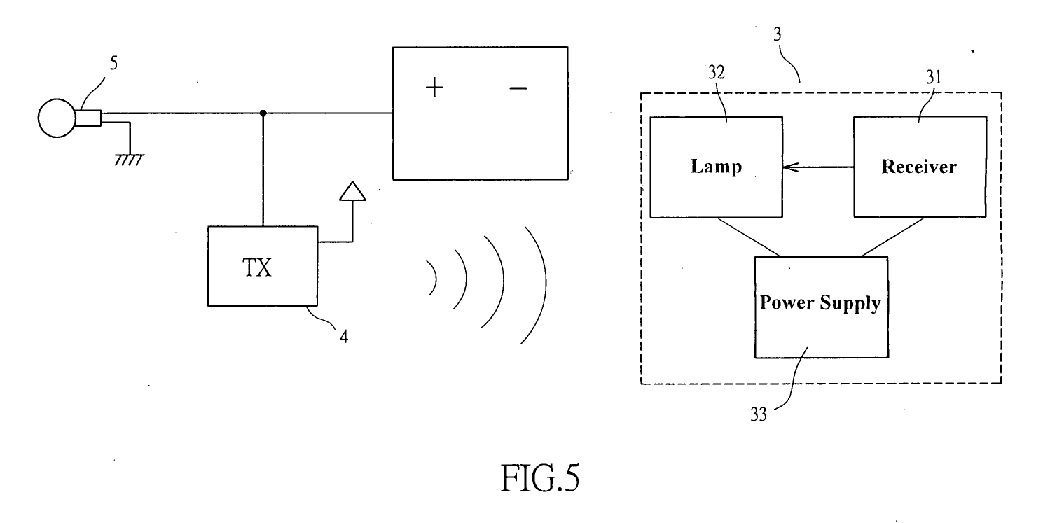

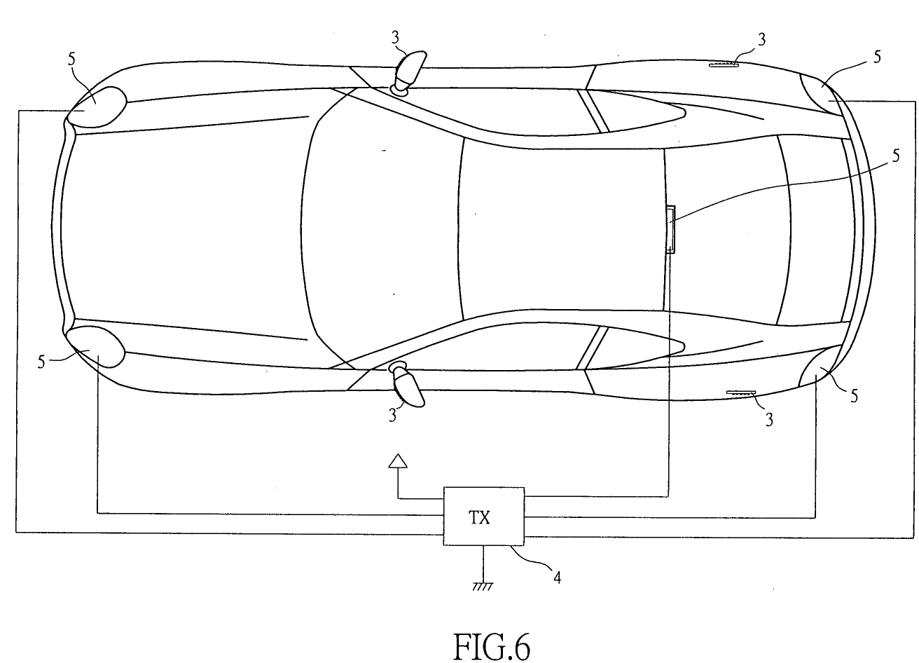

Now referring to FIG. 5, the radio transmitter 4 is coupled to an actuation system of any indicator 5 in the automobile. If the radio transmitter 4 is coupled to a direction indicator control lamp 51 of an indicator 5, the transmitter 4 sends radios to the receiver 31 of the warning lamp 3 once the direction indicator control lamp 51 is activated; meanwhile, as the direction indicator control lamp 51 emits light, the bulb 32 in the warning lamp 31 emits the light at the same time to fortify the warning effects. Furthermore, as illustrated in FIG. 6, the radio transmitter 4 is coupled to activation systems of multiple indicators 5 of the automobile according to the control by the electronic circuit designed for the transmitter 4. Multiple warning lamps may be fixed to multiple locations on the body of the automobile with the encrypted code and frequency for receiver 31 of each warning lamp 3 adaptable to the radio transmitter 4 to offer even more comprehensive application.

Accordingly, the warning lamp 3 of the present invention can be mounted to any selected location on the body of the automobile. The radio transmitter 4 sends signals in synchronous with the operation of the existing indicator 5 for the bulb 32 of the warning lamp 3 to emit light synchronously with each indicator 5 to reinforce the warning effects of the existing indication to further improve drive safety.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automobile warning device includes a warning light containing a radio receiver, a radio transmitter, and a power supply; the warning lamp containing one or multiple bulb; the transmitter being coupled to an actuation system of any existing indicator in the automobile and sending signal when the indicator is activated to the radio receiver; and the radio receiver picking up the signal from the transmitter to turn on the warning lamp to improve warning effects and upgrade drive safety.

2. The automobile warning device of claim 1, wherein, the bulb is related to a tungsten lamp or an LED bulb.

3. The automobile warning device of claim 1, wherein, a base attached to any selected location on the body of the automobile at where can be easily seen is provided to accommodate the radio receiver, the alarm lamp, and the power supply.

4. The automobile warning device of claim 1, wherein, the radio transmitter is coupled to activation systems of multiple indicators of the automobile at the same time, and multiple corresponding alarm lamps are each mounted on any selected location on the body of the automobile.
